(19) United States
(12) Patent Application Publication
(10) Pub. No.: US 2012/0097523 A1
(43) Pub. Date: Apr. 26, 2012

(54) METHOD AND SYSTEM FOR PURIFYING SILICON

(75) Inventors: Nobuyuki Mori, Miyagi (JP); Hiroshi Yano, Miyagi (JP); Toshiyuki Shiroishi, Miyagi (JP); Takashi Ushida, Miyagi (JP); Nobuhiro Shimizu, Miyagi (JP); Noriyuki Takahashi, Miyagi (JP); Toshihiro Mitsuzuka, Miyagi (JP)

(73) Assignee: UMK TECHNOLOGIES CO., LTD., Osaki-shi, Miyagi (JP)

(21) Appl. No.: 13/266,631

(22) PCT Filed: Apr. 27, 2010
(86) PCT No.: PCT/JP2010/057511

§ 371 Date: Jan. 6, 2012

(30) Foreign Application Priority Data
Apr. 27, 2009 (JP) 2009-108513

(51) Int. Cl. C01B 33/037; B01J 19/08

(52) U.S. Cl. 204/158.2; 422/186

(57) ABSTRACT

[Objects] To improve productivity and reduce thermal energy consumption in manufacturing of high purity silicon as a raw material for metallurgical grade pure silicon.

[Means to Solve]

After conducting a first treatment of either removing boron by water-vapor added plasma arc heating or low-pressure oxygen plasma arc heating upon raw silicon contained in a hearth in a chamber to thereby putting the raw silicon into a high temperature molten state to thereby oxidizing and removing boron by evaporation, or removing phosphorus by electron beam irradiation to thereby putting the raw silicon into a high temperature molten state to thereby remove phosphorus by evaporation in an atmosphere suitable to the treatment; the atmosphere of the chamber is then changed to a vacuum atmosphere suitable to the remaining second treatment, while maintaining the silicon contained in the hearth in its molten state, and the second purification treatment is conducted; whereafter end(s) enriched in impurities is cut off by way of one-way coagulation method to obtain a high purity refined silicon ingot highly free from phosphorus, boron and other impurities.

### FIELD OF TECHNOLOGY

The present invention relates to a method and a system for purifying silicone and, in particular, to a method and a system for manufacturing high purity silicon through an effective and highly yielded removal of impurities such as phosphorous and boron from raw silicon in a metallurgical manner.

### BACKGROUND TECHNOLOGY

High purity silicon is used for semiconductor device and solar cell, and it has been difficult to purify it to a level high enough to meet the demands from these applications, and it has been a task urged to improve not only the purity but also the production efficiency and the yield to such high levels satisfying the demands.

The silicon for solar cell (Solar Grade Silicon: SOG-Si) is required to have a purity of 99.9999% (6N) or higher, which is less strict than in the case of the silicon for semiconductor device, which must have a purity of 99.999999999% (11N) or higher, but the cost reduction (for the SOG-Si) is an urgent demand.

Commercially available metallurgically manufactured metallic silicon (MG-Si) to be used as the starting material for these applications has a purity of 99.5% or so, and contains many impurities, so that it requires many purification processes. Of the impurities contained in the metallic silicon, aluminum, iron, titanium, etc. can be removed by means of a one-way coagulation method, which make use of the difference in solid-liquid distribution coefficient; and carbon can be removed relatively easily by allowing it to surface during the melt-textured growth process if it is in silicon carbide, and by oxidation if it is elementary carbon.

On the other hand, to remove the phosphorus and boron that are contained in metallic silicon as impurities is difficult and requires evaporation or oxidation process at high temperatures. As a result, the consumption of energy owing to these high temperature processes is extraordinary and besides the silicon loss during such thermal treatment is so profound that it is called for to improve the cost and efficiency situations while improving the purity aspect.

A metallurgical process whereby silicon for solar cell is obtained in large quantities from commercial metallic silicon was developed in New Energy and Industrial Technology Development Organization (NEDO) and the result was published.

Citing the technology described in Non-IP Publication 1 as an example of prior art, it consists of a step wherein, using commercial silicon as the starting raw material, phosphorus, which has a higher vapor pressure than silicon, is removed by evaporating it from molten silicon in a vacuum atmosphere and a later step wherein the boron in the molten silicon is oxidized by water-vapor added plasma melting method or low-pressure oxygen plasma melting method, and then boron is removed in the form of boron oxide making use of the slight difference in vapor pressure between boron oxide and silicon or silicon oxide.

Embodiments of these steps will be explained with reference to the drawings.

In FIG. 4, the raw silicon (metallic silicon) in the shape of lump is supplied from a hopper 102 into a holding container (hearth) 103 installed in a chamber 101, which has been evacuated to 10⁻² Torr or thinner (e.g., about 10⁻³ Torr), and the silicon is heated and melt down by an electron gun 104. On this occasion, for the reason that the vapor pressure of phosphorus at the heating temperature is higher than that of silicon, the phosphorus evaporates from the melt surface and is removed.

The molten silicon after the removal of phosphorus is cast into a mold 106 for one-way coagulation, and is coagulated from below while being heated from above by an electron gun 105, and that end portion which is rich with impurities is cut away and thus a purified silicon ingot devoid of phosphorus and other impurities but inclusive of boron is obtained.

Next, the purified silicon ingot as obtained in the above-described process is pulverized, washed and thereafter supplied, as shown in FIG. 5, to a holding container 113 installed in a chamber 111, whose interior pressure is maintained at a value somewhat lower than the atmospheric pressure (about 200-400 Torr), and is heated by a plasma torch 114 in a manner of water-vapor added plasma arc heating or low-pressure oxygen plasma arc heating whereby the silicon is melted and boron is oxidized and, by virtue of the fact that the vapor pressure of boron oxide at higher temperatures is slightly higher than that of silicon or silicon oxide, this boron oxide is removed after evaporating from the surface of the melt.

The molten silicon after the removal of boron is, similarly as the afore-mentioned, is cast into a mold 116 for one-way coagulation, and is coagulated from below while being heated from above by a plasma torch 114, and finally that end portion which is rich with impurities is cut away and thus a highly pure silicon ingot is obtained.

With respect to high purity silicon obtained in the manner described above, the purity details are reported as in Table 1 below.

TABLE 1
(unit: in mass ppm)

| | P | B | Al | Fe | Ti | C |
|---|---|---|---|---|---|---|
| raw | 25 | 7 | 800 | 1000 | 200 | 5000 |
| material | | | | | | |
| MG-Si | | | | | | |
| aimed | <0.1 | 0.1-0.3 | <0.1 | <0.1 | <0.1 | <5 |
| quality | | | | | | |
| result of | <0.1 | 0.006-0.1 | <0.1 | <0.05 | <0.01 | <5 |
| development | | | | | | |

As described above, as the result of the development relating to Non-IP Publication 1, the high purity goal demanded for the silicon for solar cell was reached, and, according to the report, a relative resistance of 0.006-0.013 m was achieved.

Like this, there has been developed a method for manufacturing high purity silicon satisfying requirements for solar cell application, however, it has become clear that these processes consume tremendous amounts energy and that the loss of silicon is extraordinary.

In particular and first of all, inasmuch as the phosphorus removal process by means of electron beam irradiation includes melting of silicon by irradiating electron beam at the raw silicon contained in the hearth inside the chamber maintained at a vacuum level of as thin as 10⁻² Torr or thinner, and inasmuch as that the boron removal process by means of water-vapor added plasma arc heating or low-pressure oxygen plasma arc heating includes melting of silicon by irradiating water-vapor added plasma arc or low-pressure oxygen plasma arc at the lumps of purified silicon contained in the hearth inside the chamber maintained at a pressure somewhat lower than the atmospheric pressure (about 200-400 Torr), these processes were respectively conducted in a silicon purification system consisting of separate chambers.

On account of this, the purified molten silicon from which phosphorus is removed by means of electron gun is one-way-coagulated to form the purified silicon ingot, and this purified silicon ingot is pulverized and washed and is used as the raw material for boron-removal process which is based on water-vapor added plasma arc heating or low-pressure oxygen plasma arc heating. As is seen, the phosphorus removal process based on electron beam irradiation and the boron removal process based on water-vapor added plasma arc heating or low-pressure oxygen plasma arc heating are both mandated to melt down the consolidated silicon raw material into molten silicon, and thus the melting of the consolidated silicon has to be repeated in each process, which bars the efforts to reduce the energy consumption.

On the other hand, both the phosphorus removal process and the boron removal process are processes wherein the raw material silicon contained in each hearth is rendered into a molten state by increased temperatures coming from the irradiation of electron beam, water-vapor added plasma arc heating or low-pressure oxygen plasma arc heating, so that a considerable amount of silicon is caused to evaporate and lost, and furthermore it is not avoidable to increase the consumption of the energy profoundly for the heating.

To explain this in further detail, the phosphorus removal process makes use of the fact that the vapor pressure of phosphorus is higher than that of silicon, and therefore it is necessary to conduct the evaporation of phosphorus at a temperature higher than the melting point of silicon, and by virtue of the facts that the phosphorus in silicon is removable in a short time and that aluminum and calcium are also removable simultaneously as phosphorus, the electron beam 104 is used as the heating means, and water-cooling copper hearth is employed as the container 103 to hold the silicon. Now, when the silicon is melted by electron beam irradiation, the heating takes place from the melt surface so that the molten silicon is cooled as it touches the hearth's inner wall and is immediately coagulated to form a solidified layer (skull). This phenomenon is principally unavoidable either when the container used is a water-cooling copper hearth or when it is a graphite hearth.

The existence of such solidified layer is an obstruct to the silicon purification reactions, and when the refining of the silicon has progressed and the concentration of the impurities in the molten silicon has gone low, the skull becomes a source of impurities to the purified silicon through diffusion of the impurities from within the solidified layer and also through partial melting of the solidified layer. For this reason, the thickness of the solidified layer is controlled by increasing the temperature of the molten silicon with an increased irradiation magnitude of the electron gun. However, when the temperature of the molten silicon is raised by means of heating the melt surface with an irradiation of electron beam, the temperature of the melt surface is simultaneously increased profoundly so that silicon evaporation is caused and its loss would reach no less than 20%.

Furthermore, this process for removing impurities through evaporation proceeds with evaporation of the impurities from the surface of the melt, so that the rate of the removal is determined by the movement of the impurities in the melt to the melt surface; however, since the natural convection within the melt is not sufficient, the movement of the impurities such as phosphorus towards the melt surface where the reactions take place depends significantly on the diffusion and the like, and thus the removal of the impurities is retarded. Therefore, it has been proposed to stir the melt through horizontal rotation of the melt container, or through application of ultrasonic wave, etc., but as it is not possible to stir in a manner such that the melt in the middle is moved toward the surface, the problem has not been solved yet.

The molten silicon which has been melted by the electron beam gun and from which the impurities including phosphorus have been removed is turned to be a purified silicon ingot through one-way coagulation method. This purified silicon ingot is pulverized and washed and thereafter supplied, as the silicon raw material for the subsequent boron removal process. However, the purified silicon from which much of the impurities has been removed through the electron beam melting process and the one-way coagulation process, cannot but receive new impurities during the pulverization step. The washing of the raw material silicon after the pulverization cannot entirely do away with the new comer impurities. Therefore, the burden of removing the impurities that entered during the pulverization has to be distributed to the boron removal process based on the water-vapor added plasma arc heating or the low-pressure oxygen plasma arc heating and the subsequent one-way coagulation process.

Similarly, the boron removal process proceeds with oxidation of the born and the evaporation of the resultant oxide, so that the two steps take place both in the melt surface. Hence, transportation of boron to the melt surface must work and the oxidation of the boron cannot but be accompanied by oxidation of silicon. As the result, the silicon oxide covers and shuts the melt surface off the atmosphere, wherefore controlling or removal of the oxide should be conducted simultaneously lest the boron removal process be thwarted.

In the above-described boron removal process, the oxidation of boron and the evaporation of the boron oxide are caused by means of the plasma arc heating and controlling of an oxygen-containing atmosphere, but as the silicon oxide produced by the oxidation of silicon starts covering the melt surface, the progress of the boron removal process is retarded. On account of this, these boron removal steps at high temperatures require lengthy treatment time periods in order to attain the aimed extent of boron removal, and as such the amount of energy put in for heating becomes huge and the loss of silicon through oxidation and evaporation is not small. Also, similarly as in the case of the removal of phosphorus, in the boron removal process the melted silicon is cooled as it touches the hearth's inner wall and is immediately coagulated to form skull consisting of the solidified layer. Therefore, the thickness of the solidified layer is controlled by increasing the temperature of the molten silicon with an increased magnitude of the plasma arc heating. However, when the temperature of the molten silicon is raised by means of the plasma arc heating and the controlling of the oxygen-containing atmosphere, the temperature of the melt surface is simultaneously increased profoundly so that silicon evaporation and oxidation are promoted and its loss would reach as much as 40% of the starting raw silicon. Also this causes a problem of many a deposition of evaporated matters on the refinery apparatus.

Therefore, in the boron removal process as well, it is necessary that the boron within the melt moves speedily toward the melt surface where the reactions take place, and it is necessary at once to work out a condition whereby the oxidation and the evaporation of boron proceed promptly by removing the silicon oxide layer from the melt surface, and to effectively make the solidified layer melt and oxidize, similarly as in the case of phosphorus removal.

Furthermore, each of these respective purification processes for removal of phosphorus and boron is repeated separately and includes the purification process based on one-way coagulation so as to retain the purity and avoid contamination, so that the cost for energy and the process time account for a large percentage of overall cost and time, and hence it has yet to be improved in terms of cost and productivity.

Summing up, the silicon purification process steps as described above were conducted separately and the molten silicon after the respective treatment step was purified with respect to other impurities by one-way coagulation and the thus coagulated ingot was pulverized and was poured to the subsequent purification process such as boron removal process or phosphorus removal process. In this purification process, not only the purification process is complicated but also the input energy amounted to extraordinary levels, for the solid silicon was melt down in each of different purification steps.

As opposed to this, if the removal of phosphorus and that of boron can be conducted in the same vacuum chamber consecutively, not only the production efficiency would be improved but also the energy consumption should be way reduced; however, the atmosphere and the heating means adopted by these purification steps differ between them so that it was difficult to put this idea into practice.

Now, if the boron removal step and the phosphorus removal step and also the subsequent one-way coagulation refining step are conducted on end, not only the energy consumption per each step can be considerably reduced but also the production efficiency is extraordinarily improved; but to do this the following problems had to be solved, and it has not been easy to achieve these goals.

As stated above, the phosphorus removal step has to be conducted in a high level vacuum atmosphere, whereas the boron removal step can proceed in an inert gas plasma atmosphere including oxygen and water vapor at a pressure lower than the natural atmosphere.

Then, the heating by means of these electron beam and plasma irradiation is effective only in the aforesaid atmospheres. Therefore, in the juncture of exchanging these atmospheres, since there is not a means available to heat the once molten silicon, the silicon cannot but be left to release heat, and what with the cooling done to the water-cooling hearth or the melt purification container, the temperature drops and the silicon solidifies in a very short time. When the silicon is once solidified, it is very difficult for the heating means to re-melt it from the solid surface, the re-melting and refining from this state is impossible.

Furthermore, in order to exchange the atmospheres, namely from the high level vacuum for phosphorus removal step to the atmosphere appropriate to plasma irradiation, and then from the atmosphere for plasma irradiation to a high level vacuum, it would take at least several tens of minutes even when an evacuation system consisting of a combination of a booster pump such as a turbo molecular pump or a roots pump with a fore pump such as a rotary pump, which are known as the vacuum pumps to achieve such high level of vacuum, and even the capacity of these vacuum pumps is increased, the atmosphere exchanging cannot be achieved in such a shot time as would enable the above-mentioned continuous purification process.

### PRIOR ART PUBLICATIONS

### IP Publications

[IP Publication 1] Japanese Patent No. 3473369
[IP Publication 2] Japanese Patent No. 3369094

### Non-IP Publications

[Non-IP Publication 1] No. 1 “Energy use Rationalized Silicon Manufacturing Process Development” (Rating after the Affair) Divisional Group, Document 6-2, Dec. 21, 2001, New Energy and Industrial Technology Development Organization (NEDO) Solar/Wind Force Technology Development Room Material Technology Development for Solar Cell Association (SOGA)
[Non-IP Publication 2] “Evaporation Removal of Phosphate and Boron In Molten Silicon”, Japan Metal Academy, No. 54, Part 2 (1990) 161-167

### SUMMARY OF THE INVENTION

### Problems the Invention Seeks to Solve

It is an object of the present invention to suppress the loss of silicon, to minimize the amount of energy consumed, to reduce the burden arising from the deposition of evaporated matters in the purification apparatus, to improve the effectiveness at the steps of impurity removal and silicon refining, to reduce the cost and to achieve a high level purity.

More specifically, it is an object of the invention to try to improve still more the productivity and energy efficiency through improvement of the purification efficiency by continuously and repetitively conducting the removal and refining steps of phosphorus and boron in the same chamber while switching its atmosphere, and by continuously conducting whole purification process over and over again.

### Means to solve the Problems

According to the present invention, a silicon purification method is proposed, which

includes a step for removing boron after oxidizing it by irradiating plasma upon a silicon melt surface in a lower level vacuum atmosphere consisting of an inert gas plus water vapor or oxygen within a vacuum chamber,
and further includes a step for evaporating and removing phosphorus by irradiating electron beam upon the silicon melt surface in a higher level vacuum atmosphere,
and which is characteristic in that
either one of the purification steps of plasma irradiation and electron beam irradiation is conducted in the respective one of the atmospheres, and then, while maintaining the molten state of the melt silicon without a use of the other heating means, the atmosphere in the vacuum chamber is switched to the other atmosphere, whereby a next purification step may be thereafter started continuously;
and more specifically, in a combination of a fore pump and a mechanical booster pump, which are used as vacuum pumps, two or more booster pumps are connected in series to thereby obtain a compression ratio which is the sum of those of the booster pumps whereby the vacuum exhausting flow rate corresponding to the vacuum pulling of the gas body as a viscous fluid of a relatively low vacuum level is increased sharply so that in a short time it reaches the range of functionally capable pressure of a large volume diffusion pump as the main pump,
and as the result, it is now possible to change the atmospheres in a very short period of time during which the silicon after going through the previous purification step remains molten without the help of other heating means.

As the suction of the vacuum chamber or switching to a vacuum atmosphere of a high degree of vacuum following the purification step of plasma irradiation conducted in a relatively low degree of vacuum is completed within several tens of seconds, it is now possible to conduct the phosphorus removal step and the boron removal step upon one batch of silicon in a series or through a serial combination of these steps in which the order can be arbitrarily chosen to effect the purification.

By virtue of this fact, the productivity of the purification process is extraordinarily improved, and it is possible to supply the molten silicon to the subsequent one-way coagulation step in a continuous manner, and thus it will be necessary to make the total purification process including the one-way coagulation step flow without a break.

For this reason, in the present invention, in order to expedite the one-way coagulation step, which requires a substantial period of treatment time, so as to make it commensurate with the phosphorus and boron removing steps, there are provided a plural number of one-way coagulation apparatus which operate simultaneously with each other whereby the entire process is arranged without a break.

In order to conduct the phosphorus removal step and the boron removal step upon silicon consecutively, it is necessary to change the atmosphere of the vacuum chamber from the inert atmosphere of low degree of vacuum to the high-degree vacuum atmosphere wherein electron beam heating is possible within a very short time period, several tens of seconds at most, during the span of which the molten silicon barely solidifies even without the help of a heating means.

Conventionally, in order to attain such high degrees of vacuum like 10×10-2 Torr or thinner, the practice was to provide in front of the fore pump a turbo molecular pump or a roots vacuum pump, which are operable on high degree vacuums, as the booster pump; however, the present inventors found, although it may depend on the volume of the vacuum chamber, it took about 30 minutes to attain the target vacuum degree in the vacuum chamber used by the inventors and during this time period the melt state was not maintained.

In the range of the vacuum degrees in which the booster pumps are operable, as the vacuum degree increases the denseness of the gas molecules is lowered and the mean free paths of the gas molecules increase with the result that the gas as a whole stops behaving like a fluid but starts moving more freely and with increased diffusiveness.

On account of this, pumps such as rotary pump, which are used for relatively low degrees of vacuum such as 10⁻² Torr or lower at which the gas behaves like a fluid and flows so as to make uniform the overall pressure, fail to suck the gas molecules and stop functioning when too high a degree of vacuum is reached and the gas denseness becomes too thin. As opposed to this, pumps such as mechanical booster pump, when installed in front of these pumps to let the latter function as the fore pump, enable the fore pump to keep sucking effectively from the vacuum, because they impart one-direction kinetic energy to the gas molecules by means of their high-speed spinning fan, etc. to thereby compress the molecules.

By using a combination of the fore pump workable in relatively low degree vacuum and the booster pump workable in relatively high degree vacuum, it is possible to attain a high vacuum such as 10⁻¹⁰ Torr or thinner; however as the aimed degree of vacuum becomes higher the required time is lengthened exponentially, so to speak, so that the pumping capability has been a big wall for the practice of treatments requiring high-degree vacuums. For this reason a series of treatments are conducted in the same vacuum without breaking it, or the batch volume for one treatment is increased as it is difficult to alter the vacuum.

As the result of studying various combinations of mechanical booster pumps such as turbo molecular pump and roots pump with fore pump which can attain the high degrees of vacuum, the present inventors reached a postulation that the gas molecules compressed by these booster pumps workable at the high vacuum range are not exhausted directly by the fore pump but are stayed, or reserved so to speak, until they are compressed and built up to a vacuum degree at which the fore pump is workable, and only then they are sucked and gradually exhausted, in view of the fact that the time required to attain the target degree of vacuum increases sort of exponentially with the target value.

In such high vacuum situation, even the booster pump is not able to exhibit its capability sufficiently, because the difference in density between the vacuum system and the exhaustion system is increased so that a large number of the gas molecules in free motion leak back to the vacuum system following a probability theory.

A condition that invites this kind of situation is that the exhaustive pumps such as rotary pump which are used as the fore pump generally work suitably for a middle-class vacuum of degrees 10⁻¹⁰-10² Pa to a low-level vacuum of degrees 10²-10⁴ Pa.

As opposed to this, the mechanical booster pumps generally used as the booster pump target vacuum degrees of 10⁻² Pa-10⁻⁴ or stronger; however, in the present invention there is a difference of at least four orders in vacuum degree between the vacuum atmosphere for the plasma irradiation and that for the electron beam irradiation, and in order to achieve an evacuation across this pressure difference (density difference) a stronger mechanical booster pump seems needed.

However, inasmuch as the fact that a conventional booster pump can attain such a target in the aforementioned time period, a booster pump that overcomes such high pressure difference was not necessary needed for the purpose of attaining the high-level vacuum.

In view of this, the present inventors tested various combinations of booster pumps to see if the difference in the pressure or density is overcome by them. As there is no commercial mechanical booster pump available that attains such a goal alone, the inventors connected a plural number of commercial mechanical pumps in series and attained the goal.

FIG. 7 is a graph wherein the time required to arrive at the respective vacuum degree is plotted in the case of A, which is of a conventional vacuum system using one unit of a mechanical booster pump in combination with a fore pump, and in the case of B, which used two mechanical booster pumps in series and one fore pump in combination.

From this graph, it is seen that the time required increases sort of exponentially with the degree of vacuum targeted, but in the case of B, the gradient is sharp meaning the evacuation flow rate has greatly been increased.

As the result, in the case of the installation of the inventors, the time required to bring the atmosphere from the vicinity of atmospheric pressure to the vacuum of a degree of 10×10⁻² Torr was about 30 seconds—it was about 30 minutes using a system of a conventional booster pump.

It is generally thought that to increase the compression ratio of a pump such as booster pump does not directly cause an increase in flow rate, but in the case of the construction used in the present invention, it is thought that the operational obstacle due to the differences in operational principle and properties between the booster pump and the suction pump as described above has been removed, and as the above result shows a huge improvement was made in the exhaustion velocity.

The construction required of the booster pump of the present invention is such that the compression ratio of the booster pump enables attainment of the pressure and density at which the suction pump for viscous fluid is workable upon the targeted vacuum, and as a result of connecting a plural number of booster pumps in series with a target degree of vacuum of 10⁻⁴-10⁻² Pa, the resulting compression ratio summed up to such a large value as to produce the pressure and density at which the gas starts behaving as fluid, so that it is thought that the conditions for the fore pump to work effectively was established and the vacuum exhaustion flow rate became such as is expected from the pump.

As these conditions were established only through this system consisting of a mechanical booster pump and a sucking pump such as rotary pump, it is not clear whether a similar result is obtained by a system based on a different operational principle; however, at least with a pump system consisting of vacuum pumps of the same principles, similar degrees of vacuum are thought to be attained respectively.

The present inventors also paid attention to the properties of the electron beam irradiation apparatus and, through the following contrivances, attained the maintenance of the molten state between the steps and rationalization of the purification steps.

A divided pressure stage was formed in the emission chamber of the electron beam irradiation apparatus, and a differential pumping mechanism consisting of a turbo molecular pump is attached to this, and by forcibly creating a state of a high vacuum of a degree of 10⁻² Torr at the exit of the electron beam irradiation apparatus by means of the pressure stage it becomes possible for the electron beam irradiation apparatus to operate effectively even though the melting chamber is not sufficiently evacuated.

By virtue of this, what with the afore-mentioned high velocity evacuation by means of the tandem booster pump, it is now possible to further shorten the time period required to change the vacuum atmospheres.

As the result, it is possible to start the operation of the electron gun as soon as when the melting chamber's atmosphere gets in the vicinity of 0.5-5 Torr, which is the lower limit for the effective working of the plasma torch, and thus it is possible to start the electron beam irradiation while the molten silicon in the hearth after being melted by the plasma irradiation keeps molten. Some kind of electron gun can securely output about 60% of its capacity in a chamber of 1 Torr by the help of the differential pumping of the pressure stage so that the above-mentioned process is sufficiently enabled.

Therefore, it is one of the features of the present invention that during the changing of the vacuum atmospheres for the melting chamber, by virtue of the mechanism for differentially evacuating the pressure stage of the electron gun, it is possible to operate the electron gun effectively even when the vacuum atmosphere which enables the effective operation of the electron beam within the chamber is not yet been attained, so that it is now possible to start irradiating the electron beam within the time period wherein the silicon in the hearth remains molten.

Now, the plasma irradiation used in the boron removal step consumes a large quantity of heat and pushes the temperature very high, but such a high temperature is not required to oxidize and evaporate the boron in the molten silicon so that even when plasma irradiation is applied to the melt surface, much of the heat is lost in the cooling water flowing the torch's main body and in heating the added water vapor and in radiation within the vacuum chamber in the low-degree vacuum state and the cooling of the purification container, so that the plasma irradiation itself is the cause of a large loss of energy; in contrast to this the electron beam heating makes use of resistance heating by passing electricity from the melt surface to the deep of the melt, so that although the energy created by the electron beam irradiation itself is not large, it can be said as an effective and energy-efficient heating means. Thus, in the present invention, before shifting to the inert gas atmosphere for plasma irradiation, the electron beam irradiation is conducted under the vacuum condition, and the temperature adjustment required for the steps of the melting of the raw silicon and the removal of boron is conducted. Also, the electron beam is used as a molten state maintenance heating means for maintaining the silicon's molten state so as to make sure that the molten silicon in the hearth after plasma irradiation pours into the molten silicon holding container.

In the case of plasma irradiation, its total energy efficiency contributing to the silicon heating is estimated to be about 55% owing to the various above-mentioned losses, and furthermore, due to the limitation to the velocity of sweeping (scanning) the molten silicon in the hearth, even if molten silicon is formed in the hearth, it is difficult to maintain the molten state of the silicone throughout the entire area of the hearth. In contrast to this, in the case of heating with electron beam, since there is no other cause for substantial loss of energy besides the consumption by the cooling of the electron gun so that the ratio of the energy eventually used in heating the silicon to the entire energy input is about 97%, and furthermore for the reason stated in relation to the plasma irradiation, it is easy with electron beam to maintain the molten state of the molten silicon throughout the entire area of the hearth.

Therefore, to conduct the electron beam heating under the condition wherein the vacuum atmosphere is maintained is highly profitable for the industry in productivity and energy economy. Hence, it is the most preferred embodiment of the present invention to first apply the electron beam irradiation to the raw silicon supplied in the hearth to thereby melt the raw silicon, then to apply plasma irradiation to the silicon, and again apply the electron beam irradiation to thereby render the silicon in the hearth uniformly molten (if necessary, apply the plasma irradiation again and then final electron beam irradiation).

Thanks to the above-described method, it has become possible to go to the next step while keeping the molten state of the silicon between the phosphorus removal purification step and the boron removal purification step.

Also, this possibility has enabled a plurality of batches to be subjected to the purification steps without a breakthrough supplying with a vacuum feeder the raw silicon without breaking the atmosphere of the chamber, the one batch being corresponding to one cycle of the phosphorus and boron removal purification steps; and as described later, the purification method of the present invention is extraordinarily high in the purification efficiency and productivity, and also the effect of the purification steps on the molten silicon as purified is very high, but in the embodiment wherein the pursuant one-way coagulation step is combined with the phosphorus and boron removal purification steps, if a plurality of one-way coagulation apparatus, which requires a lengthy time to complete the purification step, are installed so as to enable the one-way coagulation apparatuses to operate simultaneously as the said phosphorus and boron removal steps proceed, unlike simply conducting a phosphorus and boron removal purification steps repeatedly to gain one purified unit (for example, repeating a number of times the in-hearth purification steps, each batch producing 50 kg and eventually gaining, e.g., 500 kg of purified unit) and then proceed to the one-way coagulation, then it is possible to conduct a series of the purification steps—from the phosphorus and boron removal purification steps through the one-way coagulation step—without a break.

Also, in the present invention, by combining the methods of moving the molten silicon relative to the melting container and of melting the skull sticking to the melting container during the said phosphorus and boron removal purification steps, the purification effect is improved and the purification efficiency is greatly improved.

In other words, in the step for removing boron from the molten silicon by oxidation and the step for removing phosphorus therefrom by evaporation, all parts of the coagulated silicon layer formed on the container wall are exposed one part after the next or one part after the opposite, by moving the molten silicon hither and thither and up and down continuously to thereby cause heating sources of the plasma and electron beam to irradiate and melt the coagulated layer to thereby promote the purification process.

Also, this purification promotion step is conducted by using a melting container for molten silicon having a tilted rotational axis, or the purification promotion step is conducted by tilting the melting container for molten silicon in the opposite directions alternately, whereby

the said purification promotion step proceeds as the melting container for molten silicon turns non-horizontally and as the melting container see-saws to and fro.

Meanwhile, the plasma gas irradiation and the electron beam irradiation are led to scan over the silicone melt as well as the silicon coagulated layer (skull) formed on the melting container's inner wall to thereby melt and let flow the coagulated layer as well as the entire molten silicon whereby agitation is caused.

As the phosphorus removal and boron removal purification steps involve evaporation and oxidation which proceed in the molten silicon surface, the fact that, as the result of the melting and fluidization of the skull and the agitation of the molten silicon, a thorough and uniform circulation of the entire body of the molten silicon causing the molten silicon in deep to be continuously brought to the reaction-occurring melt surface contributes to bringing about of an ideal purification efficiency and also an avoidance of over heating of the surface layer of the melt by the electron beam or the plasma irradiation, so that an excessive evaporation of the silicon and an excessive oxidation of the silicon are prevented and thus there occurs less hindrance to the boron removal by the excessively formed silicon oxide layer wherefore effective phosphorus removal and boron removal are attained.

In the present invention, it is desirable that after the purification steps of phosphorus removal and boron removal, the one-way coagulation step is conducted.

Incidentally, though the productivity of the phosphorus removal and the boron removal steps are extremely high, it is not necessarily a good thing to adopt a large-volume melting container for the boron removal and the phosphorus removal steps, because, as said above, the phosphorus removal and the boron removal purification events take place in the melt surface, and to make the volume of the melting container larger means smaller specific surface area and hence it is not effective to improve the purification efficiency, and means longer reaction time required and the purification effect of the phosphorus removal and boron removal steps would be impaired.

Therefore, in the present invention, there is a range for appropriate volume of the melting container, and it is desirable that, after repeating a number of times the paired steps of the phosphorus removal and the boron-removal—each pair producing one batch—until a required amount of silicon is obtained, the required amount is supplied to the next one-way coagulation step.

Further, in the present invention, the productivity of the phosphorus removal and the boron removal steps is extremely high, but in contrast to this, the one-way coagulation step proceeds so slowly that in order to make a continuous production line of these it was necessary to install a plurality of one-way coagulation apparatuses which can operate simultaneously, and after the phosphorus removal and the boron removal purification steps the pooled amount of a number of batches has to be transferred to these one-way coagulation apparatuses.

Furthermore, when the phosphorus removal and the boron removal steps are designed to succeed each other without a break, it becomes necessary to alternate frequently between the creation of high vacuum by evacuation and the creation of a first atmosphere through introduction of an inert gas; it is effective if the inert gas thus introduced into the high vacuum atmosphere is drawn out and passed through a filter for removal of impurities, and is reserved temporarily, and then it is re-introduced into the vacuum chamber on the occasion of the creation of the next inert gas atmosphere.

As the impurities contained in the inert gas recovered after these steps can be removed by means of the filter after the cooling, it is possible and profitable to reserve the inert gas in a reserve tank and then reuse it whereby the production efficiency is improved and the cost per unit is reduced.

In order to conduct the above-described purification method, the present invention provides a system which includes:

a vacuum chamber adapted to change its inner atmosphere between a lower-degree vacuum atmosphere and a higher-degree vacuum atmosphere,
a melting container for containing molten silicon installed in said vacuum chamber,
a plasma irradiation apparatus for irradiating a plasma consisting of an inert gas mixed with an oxygen-containing gas to a melt surface of metallic silicon contained in said melting container to thereby heat the molten silicon and oxidize and remove boron contained in the metallic silicon,
an electron beam irradiation apparatus for irradiating electron beam to the melt surface of the metallic silicon contained in said melting container to thereby heat the molten silicon and remove phosphorus contained in the metallic silicon by evaporation, and
an atmosphere changing means for changing from a vacuum atmosphere in said vacuum chamber in which boron or phosphorus has been removed from said metallic silicon by a heating operation upon the melt surface of said metallic silicon contained in the melting container by means of either said plasma irradiation apparatus or said electron beam irradiation apparatus to another vacuum atmosphere which is suitable to the heating operation by said plasma irradiation apparatus or said electron beam irradiation apparatus whichever has not been operated in the foregoing vacuum atmosphere, within a time period wherein said molten silicon contained in said melting container remains molten; and
this system is characteristic in that the plasma irradiation apparatus or the electron beam irradiation apparatus which is operated later is operated to heat the metallic silicon to thereby remove either phosphorus or boron from the metallic silicon, and
thus both phosphorus and born are removed from the metallic silicon using only one chamber and only one melting container;
and preferably but optionally,
the atmosphere changing means includes:
an inert gas supplying apparatus for supplying a gas consisting of an inert gas mixed with oxygen or water vapor to the vacuum chamber, and
a vacuum suction apparatus, as the vacuum system to evacuate the atmosphere of the vacuum chamber, consisting in series of a plurality of booster pumps connected in tandem (which create a compression ratio that attains a density at which a fore pump can suck effective) and a large volume diffusion pump and a fore pump;
the system being for removal of phosphorus and boron from silicon; and
the system's purification efficiency is improved by including a molten silicon holding container for collecting and preserving many a batch of molten silicon produced in said melting container and for providing one predetermined unit of molten silicon to the next one-way coagulation step;
further installed are a plurality of one-way coagulation purifying apparatuses, of which the one-way coagulation container is constituted by the molten silicon holding container, and these plural apparatuses constitutes a plurality of one-way coagulation lines which are commensurate with the high productivity of the phosphorus and boron removal steps, and accordingly a continuous purification system covering from the phosphorus and boron removal steps through one-way coagulation purifying step is constructed.

Also this silicon purification apparatus is characteristic in that it enables the electron beam to effectively irradiate even before the atmosphere of the vacuum chamber becomes sufficiently thin for the electron beam to occur, by means of installing a vacuum pump to the area of the electron beam irradiation apparatus where the electron beam is generated,

and furthermore, the inert gas is recovered from the exhaustion gas from the vacuum pump consisting of a number of booster pumps connected in tandem, and this inert gas is recycled back to the inert gas supply apparatus.

### THE RESULT OF THE INVENTION

According to the present invention, in the art of purification of raw silicon, the loss of silicon was reduced, the energy consumption was lessened, the burden arising from the deposition of vapor elements on the purification system was lightened, and the efficiency in the impurity removal steps was improved, and the cost was minimized, and higher purity was possible, and what is more in addition to the higher purity and lower energy cost, the production efficiency has risen extraordinarily owing to the designing of continuous operation from the phosphorus and boron removal steps through the one-way coagulation purifying step.

### BRIEF DESCRIPTION OF DRAWINGS

FIG. 1 A silicon purification system of the present invention is shown.

FIG. 2 A schematic perspective view showing a part of the silicon purification system of the present invention.

FIG. 3 A view showing steps of silicon purification of the present invention.

FIG. 4 An embodiment of an electron gun of the present invention is shown.

FIG. 5 A conventional procedure for removing phosphorus is shown.

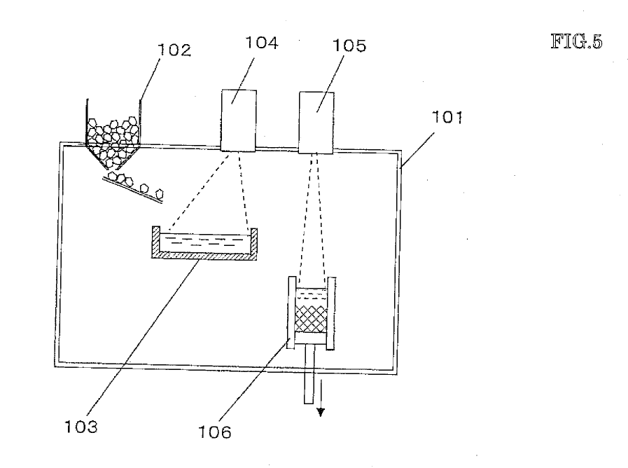

FIG. 6 A conventional procedure for removing boron is shown.

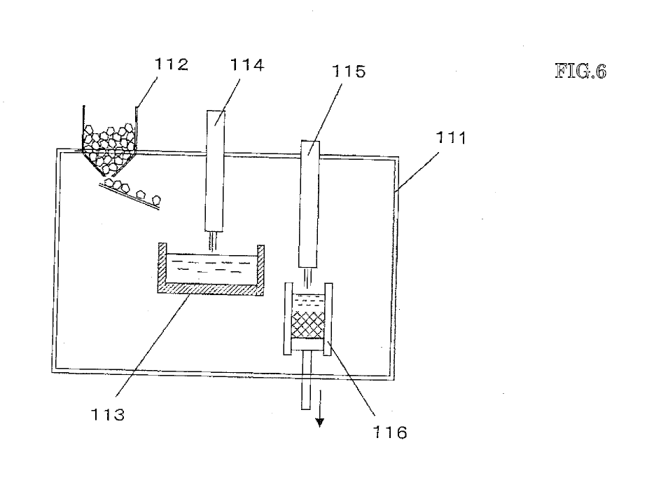

FIG. 7 A graph to show a relationship between vacuum level and the time required to reach there.

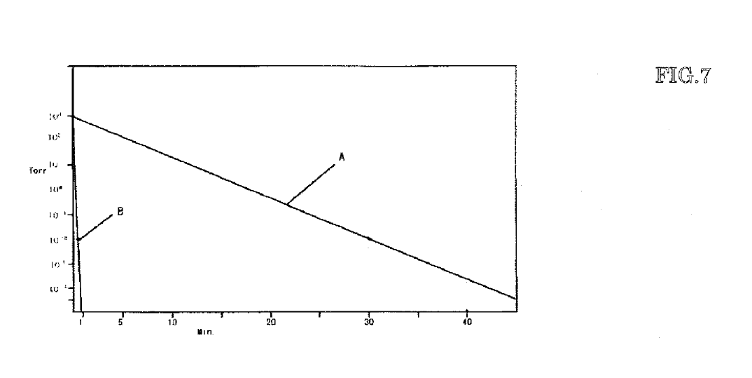

### EXPLANATION FOR REFERENCE NUMERALS

10: melting chamber
11: main body of melting chamber
12: lid of melting chamber
13: tilted rotary hearth
14: vacuum screw feeder
15: electron beam irradiation apparatus
15A: main body of electron gun
15B: pressure stage
15C(P5): turbo molecular pump
16: plasma irradiation apparatus
17-1, 2: one-way coagulation apparatus chambers
18-1, 2: gate valves
20: molten silicon holding container
21: heater
22: lifter
23-1, 2: heater
24-1, 2: heater
25-1, 2: lifter
26: platform
27: idle rollers
30: inert gas tank
31: gas supply controller apparatus
32: gas cooling and filtering apparatus
33: compressor
42: skull
43: molten silicon
24: rotary shaft (?)
P1-P5: vacuum pumps
101: vacuum chamber
102: raw silicon supply apparatus
103: silicon purification container
104: electron beam irradiation apparatus
105: electron beam irradiation apparatus
106: one-way coagulation purification apparatus
111: chamber
112: raw silicon supply apparatus
113: silicon purification container
114: plasma irradiation apparatus
115: plasma irradiation apparatus
116: one-way coagulation purification apparatus

### EXAMPLES OF PRACTICING THE INVENTION

The present inventors investigated into silicon purification method to obtain high purity silicon through removal of impurities such as boron and phosphorus, and as the result, a method was contrived in which, after conducting a melting treatment to the raw silicon contained in a hearth installed in a chamber in an atmosphere of a low vacuum degree (a step wherein the silicon is rendered high-temperature molten state by water-vapor added plasma arc heating or low-pressure oxygen plasma arc heating to thereby oxidize and remove boron by evaporation, or a step wherein the silicon is rendered high-temperature molten state by electron beam irradiation to thereby remove phosphorus by evaporation), while maintaining the molten silicon contained in the hearth in molten state within the same chamber, a rapid change is made to the atmosphere to make it a high-level vacuum atmosphere which is different from the low-vacuum inert gas atmosphere, and then the next melting step is conducted (a melting treatment different from the above-mentioned melting treatment); then, if necessary, the said melting treatment is conducted and repeated in the inert vacuum atmosphere of the low vacuum degree; and thereafter, by way of one-way coagulation method end portion(s) enriched in impurities is cut off whereby a high-purity refined silicon ingot is obtained from which phosphorus and boron as well as other impurities are removed at high efficiency, and in addition to this, with the present silicon purification method it is possible to extremely reduce the energy consumption. In the above operation, it is most preferable that the electron beam irradiation is conducted as the first treatment, and then the plasma irradiation is conducted as the second treatment, and the first electron beam irradiation is done again as the final step (if necessary, in addition to the above, the plasma irradiation and the electron beam irradiation are conducted again).

In the above, a characteristic point is that, after these boron removal and phosphorus removal steps, one-way coagulation step is conducted as the final step for removal of impurities, but according to the boron removal and the phosphorus removal steps of the present invention, the removal of these impurities proceeds effectively, and now it becomes unnecessary to go through the conventional boron removal and phosphorus removal steps wherein the silicon was solidified in the end of each step, and thus the silicon need not be solidified between these steps to put a break between them, and as a result, it has become possible to proceed to the next step while maintaining the molten state.

Furthermore, the present inventors contrived a method wherein, on the occasions of oxidizing the boron and evaporating the resultant boron oxide and evaporating the phosphorus, the plasma jet heating and oxygen atmosphere controlling, and the electron beam irradiation are conducted upon the silicon while changing the relative positions between the melting container's wall (bottom face of the container) and the silicon melt contained in the melting container by spinning the melting container non-horizontally without discharging the melt, in other words, moving the melt across the bottom face of the tilted container without spilling the melt to thereby expose that part of the coagulated layer (skull) formed on the wall of the container which happens to come higher than other parts, and also while changing the relative positions between the container's wall and the silicon melt without spilling the melt, the plasma jet heating and the oxygen atmosphere controlling and the electron beam irradiation are conducted to thereby melt the coagulated layer (skull) and at the same time it is enabled that continually different face part is exposed form the melt surface so that the boron and the phosphorus contained in the silicon are effectively removed by oxidation and evaporation.

From these pieces of knowledge, it is preferred that, in the purification procedure of the raw silicon, the electron beam irradiation is conducted as the first step to thereby uniformly melt the raw silicon in the hearth and at the same time remove the phosphorus by evaporation, and then plasma jet heating and oxygen atmosphere controlling are conducted as the second step to thereby oxidize and remove the boron by evaporation, and at the same time remove a majority of phosphorus as well (if necessary, repeat the steps so far), and finally the electron beam irradiation of the first step is conducted to uniformly melt the molten silicon in the hearth. And the inventors found that during this time period when the first step and the second step are conducted and also while these steps are repeated, it is possible to subject the molten silicon in the hearth to the second step without letting it undergo the formation and pulverization of a refined silicon ingot by the one-way coagulation, by transferring the molten silicon contained in the hearth to the second step while maintaining the molten state of the silicon.

Therefore, it is an object of the present invention, in the art of refining raw silicon, to restrict the silicon loss, to minimize the energy consumption, to lighten the burden due to the deposition of evaporation elements in the purification system, and at the same time to improve the efficiency of purification by improving removal of impurities, and cost reduction and attainment of high purification result.

Now, we will explain the method and the system for refining silicon according to the present invention with the help of the attached drawings.

### Example 1

### Summary of the Silicon Purification System

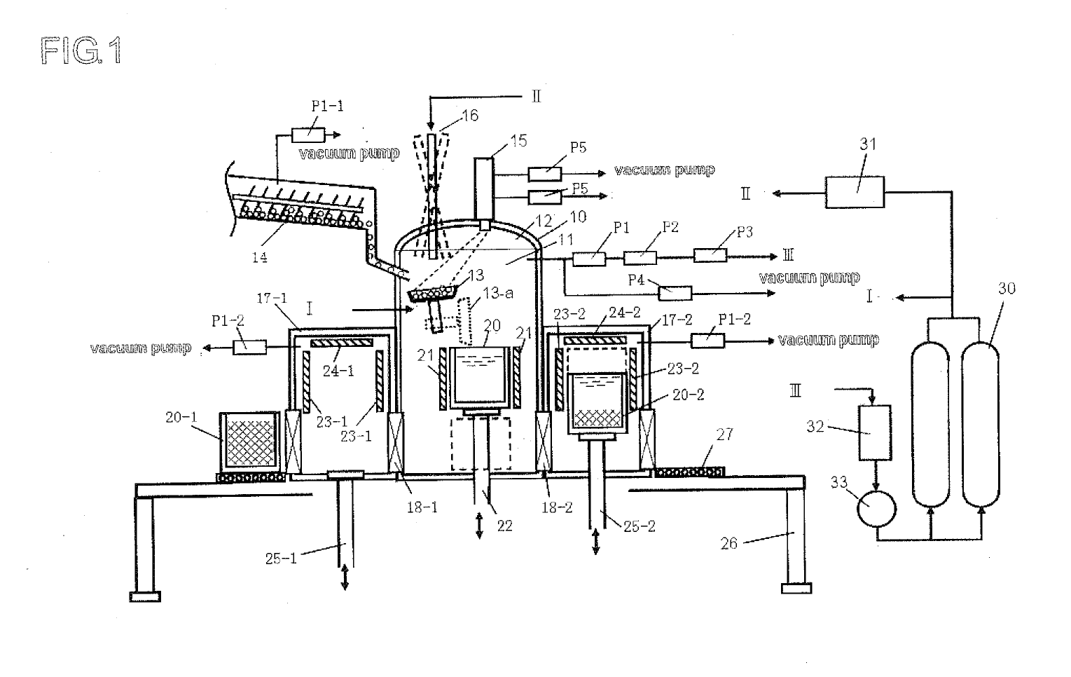

FIG. 1 shows an example of the silicon purification system according to the present invention.

Reference numeral 10 designates a melting chamber, and a plasma heating apparatus 16 and an electron beam irradiation apparatus 15 are disposed to oppose a purification container, that is, a melting container (hearth) 13 installed in this chamber 10;

a vacuum screw feeder 14 for supplying raw silicon without breaching the atmosphere in the melting chamber is installed.

The molten silicon after being freed from boron and phosphorus is poured, as the hearth is canted (13-a), into the melt holding container 20, and the melt holding container is transported to a one-way coagulation chamber 17(−1, 2) by an appropriate transportation means by way of a gate valve.

On the other hand, the one-way coagulation chamber 17 is adapted to be evacuated by an evacuating pump P1-2, and is provided with a heater 23(−1, 2) for heat retention and a heater 24(−1, 2) for heating the melt surface, and the melt holding container 20 is raised and lowered slowly by means of a lifter 25 (−1, 2) relative to the heating zone to thereby effect one-way coagulation.

The purified silicon after the one-way coagulation is brought out of the system by being carried out from the one-way coagulation chamber by way of a gate valve, whereupon the purification process is completed.

### (Evacuation Apparatus)

The main body 11 of the melting chamber forms a vacuum system in combination with an evacuation pump P4 for discharging the air from the system and an evacuation pump P3 that is a fore pump communicating with mechanical booster pumps P1, P2 in series, which characterize the present invention.

The booster pumps P1, P2 may be mechanical booster pumps such as turbo molecular pump, which causes gas molecules to move in a certain direction by a device like a fan that rotates in high speeds, and roots pump; and the fore pump can be an evacuation pump of any principle and any type, such as a rotary evacuation pump.

By connecting the booster pumps in series, the compression (ratio) of each booster pump becomes an accumulated value so that by rendering the pressure and the density of the compressed gas to be such values at which the gas exhibits fluid-like properties, it is possible to directly evacuate the system without allowing the gas to be retained by the fore pump.

In a demonstration facility of the present invention, the vacuum pump system adopted to achieve a high level vacuum was constituted by tandem booster type pump group consisting of a roots pump P1 of a capacity of 2000 m³/hr, a roots pump P2 of a capacity of 5000 m³/hr, and a rotary pump P3 of a capacity of 630 m³/hr, and by main evacuation group consisting of a diffusion pump P4 of a capacity of 30,000 liters/sec.

Now, the tandem booster type pump group consisting of P1 through P3 exhausts and recovers the inert gas from the chamber at a high rate, to thereby attain in a very short period of time the pressure range in which the diffusion pump P4 is workable, and thereafter the system is switched over to the main evacuation by means of the diffusion pump P4 so as to attain such a high vacuum in thirty seconds at which electron beam irradiation is possible.

Also the inert gas which is exhausted from the rotary pump P3 is passed through a rout III and sent to a gas cooling and filtering apparatus 32 and then to a inert gas tank 30 propelled by a compressor 33, and the thus recovered inert gas is dispatched through the gas supply apparatus 31 into the rout II to reach the melting chamber for the next cycle of the process.

By virtue of the above construction, now the atmosphere of the melting chamber can be shifted from a low level vacuum atmosphere containing inert gas with a pressure somewhat lower than the atmospheric pressure (100-400 Torr or so) which is suitable to boron removal operation based on plasma heating to a high level vacuum atmosphere with a pressure of 10⁻² Torr or lower (more preferably about 10⁻³-10⁻⁴ Torr) which is suitable to phosphorus removal operation based on electron beam heating, or more particularly it has become possible to speedily evacuate a chamber 10 having a size of an inner diameter of 2.2 m and an inner height of 2 m or so from a state of the natural atmospheric pressure down to a state of a high level vacuum of 10-2 Torr or thinner within 30 seconds.

### (Electron Beam Irradiation Apparatus)

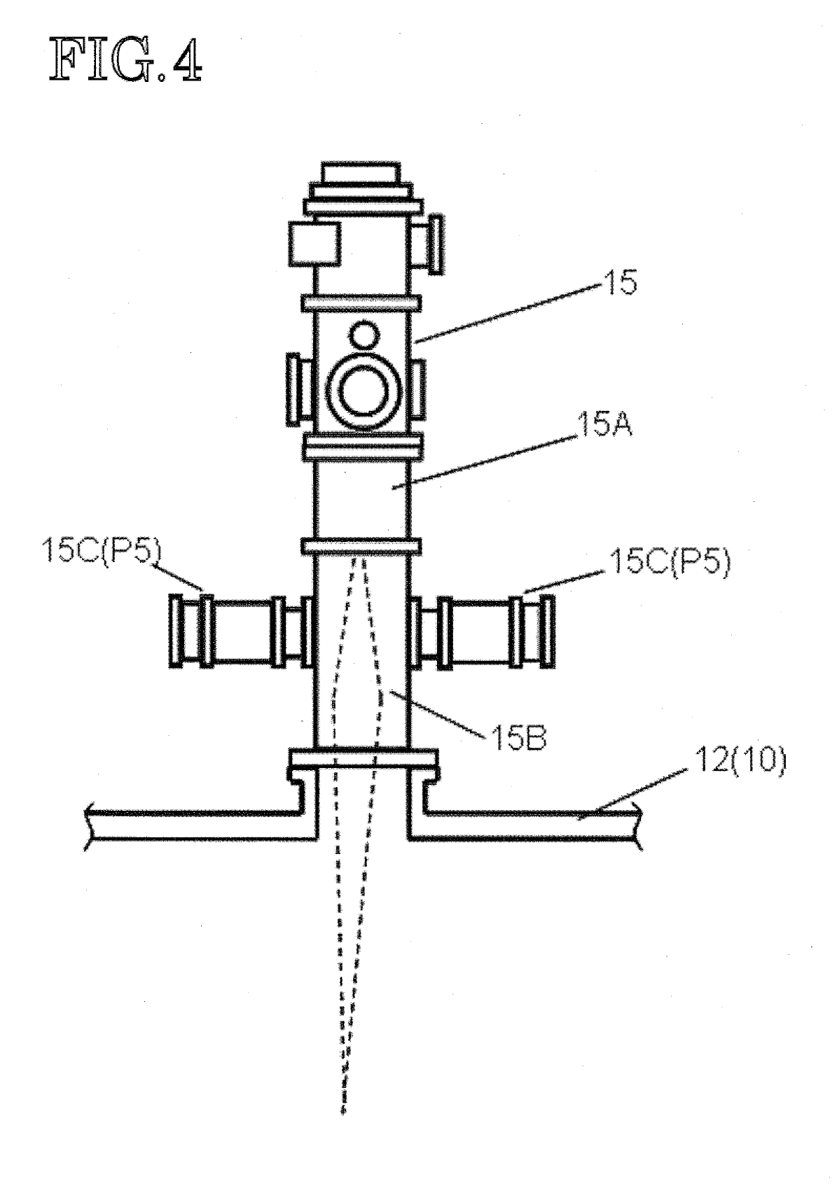

Next, the electron beam irradiation apparatus 15 of the present invention is constructed as shown in FIG. 4, and it is rendered capable of providing sufficient heat to retain the molten state of the melted silicon during the interlude in which the boron removal step is switched to the phosphorus removal step.

AS shown in FIG. 4, the electron beam irradiation apparatus 15 is constructed such that the vacuum atmosphere in the emission chamber is divided, and as depicted in FIG. 4, a pressure stage 15B is installed by being connected to the electron gun exit of the electron gun main body 15A, and via this pressure stage 15B the gun exit communicates with the lid 12 of the melting chamber 10. To this pressure stage 15B are attached two turbo molecular pumps 15C(P5, P5), and these evacuate independently from the electron gun main body 15A so that each of the turbo molecular pumps 15C is constructed as a differential pumping electron gun. The use of such differential pumping electron gun is for the purpose of enabling the electron beam irradiation apparatus 15 to function through securing of the vacuum level of about 10⁻² Torr at the electron gun exit of the electron beam main body 15A even when the internal pressure of the melting chamber 10 is not sufficiently lowered (e.g., a vacuum level of about 5×10⁻² Torr or thinner), at the time of high speed evacuation after the plasma melting of the silicon in the hearth 13 in the melting chamber 10. By virtue of this, an immediate starting of the electron beam irradiation is enabled when the inside atmosphere of the chamber 10 turns to a vacuum level at which the plasma irradiation becomes impossible, after the evacuation of the inert gas is started to complete the plasma irradiation upon the silicon in the melting chamber 10. On account of this as well as the aforementioned high speed evacuation, it has become possible to start the phosphorus removal step in a still shorter time while maintaining the molten state of the silicon in the hearth 13.

In the present invention, it is possible to start the electron beam irradiation when the atmosphere in the melting chamber is in the vicinity of 0.5-5 Torr, which is a limit for the plasma irradiation to work, and in an example when the vacuum level in the melting chamber is 1 Torr, about 60% of output is achieved, so that it has been a very useful thing that these heating means can be used at a very early time point of vacuum creating operation.

The electron beam irradiation apparatus used in the demonstration facility of the present invention was of an indirect heating type with a nominal output of 300 KW or so, and its beam operational range was controlled to cast an irradiation upon circle of diameter 800 mm on the hearth.

From the above description, it is clear that one of the present invention's objects, which is to conduct continuously the boron removal and phosphorus removal steps and the one-way coagulation treatment without a break is attained.

In other words, thanks to the performance of the vacuum system, the respective atmospheres for the plasma irradiation and the electron beam irradiation applied to the boron removal and the phosphorus removal treatments are switched over within 30 seconds, and furthermore, by conducting the electron beam heating before the required vacuum level is reached, it is possible to turn to the next purification step while maintaining the silicon in molten state.

This fact means that not only the treatment steps of boron removal and phosphorus removal are conducted continuously without a break, but also that it is possible to supply silicon in an amount of a plurality of batches as one batch into the melt holding container 20 wherein the silicon is kept in the molten state by a side heater 21 provided in the melting chamber 10, and furthermore on account of the fact that the purification efficiency and the productivity achieved through these contrivances are so high that it is possible to conduct a continuous purification process including the final step of one-way coagulation step without a break by this invention wherein the melt holding container holding the molten silicon in an amount of melt unit (e.g., 500 kg) corresponding to the amount of several batches is lowered and is transported to one of the one-way coagulation chambers 17 (for example, the one-way coagulation chamber 17-2 shown on the right hand in the figure), and this silicon on the lifter 25-2 is maintained in the molten state by means of the side heater 23-2 and the tope heater 24-2, and by lowering it at a predetermined velocity the silicon is coagulated in one way from below.

In FIG. 1, the melt holding container 20-1 in the right-hand one-way coagulation chamber 17-2 is started to go down, and the molten silicon in the bottom of the container 20-2 begins to coagulate (as shown in check pattern), and the upper part of the silicon is kept molten by means of the side heater 23-2 and the top heater 24-2. On the other hand, at the left-hand one-way coagulation chamber 17-1 it is seen that a one-way coagulation step has been finished and that the melt holding container 20-1 has been transported out from the one-way coagulation chamber 17-1. The one-way coagulation chamber 17-1 is seen to be in a waiting position, waiting for a melt holding container 20 in the melting chamber 10 to receive molten silicon and to be lowered with the silicon kept molten into a position marked in broken line, and then to receive this melt holding container 20 in itself and to raise it by the lifter 25-1 and thereafter lower it at a predetermined velocity to thereby effect one-way coagulation.

As the one-way coagulation step proceeds slowly, it takes considerable time, and therefore by installing a plurality of one-way coagulation chambers so as to effect the coagulation simultaneously as the progress of boron removal and phosphorus removal steps, it is possible to increase the productivity and to improve the purification efficiency and quality by appropriately controlling the batch volume at each treatment of boron removal step and the phosphorus removal step. Furthermore, if the one-way coagulation step is the rate-determining step as opposed to the boron removal and phosphorus removal steps handling a plurality of batches, it is possible to install another platform 26 with idle rollers 27 and another one-way coagulation chamber 17 in the space extending from the drawing paper face to thereby construct a third one-way coagulation chamber 17, and by means of this three one-way coagulation operations can be conducted simultaneously as the boron removal and phosphorus removal steps.

Furthermore, based on the size adopted in the demonstration facility of the present invention,

the atmosphere for the boron removal step was argon gas added with oxygen or water-vapor at 100-900 Torr, and the atmosphere for the phosphorus removal step was at 10⁻² Torr (preferably 10⁻³-5×10⁻⁴ Torr), and in these purification steps with a facility capable of a daily production of one ton of 6N-level high purity silicon (1.5 tons if three one-way coagulation apparatuses are installed), the final purified amount as of the end of one-way coagulation in the continuous purification process was 500 kg/batch.

The purification container (tilted rotational hearth) 13 installed in the melting chamber 10 is supported on a tilted rotational shaft, and is disposed to rotate during the boron removal and the phosphorus removal steps to thereby effect these treatments.

As the hearth is turned, its side wall and bottom face surface intermittently from above the molten silicon melt surface, and are exposed to the irradiations of electron beam and plasma so that the skull sticking to the hearth side wall and bottom face is melted and flows into the molten silicon, and also the hearth's rotational movement imparts fluidity agitation to the whole body of the molten silicon so that the molten silicon in the hearth as a whole is brought to the molten silicon surface which is the reaction interface, and thus a uniform reaction condition is established.

The goal for such movement of the hearth as the purification container as described above is to expose the skull thoroughly from the melt surface to thereby let it feel the electron beam irradiation and the plasma irradiation, and also to effect the fluidity agitation that causes a flow of the molten silicon from inside to the surface, so that it is possible to adopt, instead of tilted rotation, a seesaw movement wherein the hearth is swung about a diametrical shaft or a wobbling movement.

### <Boron Removal Step>

By means of the vacuum pumps P1, P2, the inside of the chamber 10 is sucked to a pressure somewhat lower than the natural atmosphere (100-400 Torr or so) which suits the boron removal step effected by plasma heating; and in this state a plasma jet added with water vapor or oxygen is irradiated to raw silicon or molten silicon held in the tilted rotary hearth 13 by means of an inert gas coupled plasma torch 15, whereby the silicon is heated and melted to form molten silicon, and at the same time the boron contained in the molten silicon is oxidized and it is removed from the melt surface by evaporation in the form of boron oxide.

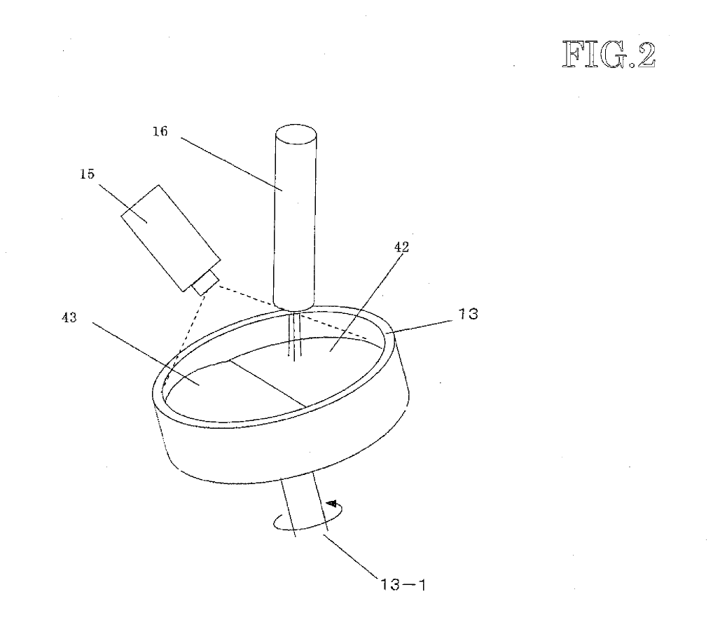

The tilted rotary hearth 13 may be, for example, a water-cooling copper hearth or graphite hearth, and the hearth shaft is tilted such that when a part the side wall (or of container bottom face) comes leftward, as seen in FIG. 2, it tips down and when it comes rightward it tips up, so that the molten silicon 43 always stays in the leftward position, and it is so designed that as the tilted shaft 13-1 is turned about its axis, any part of the side wall repeats rising and falling. As the result, the molten silicon 43 always occupying the leftward position of the hearth 13 is let to always touch newly arriving part of the side wall such that the molten silicon and the wall of the hearth 13 always move relative to each other.

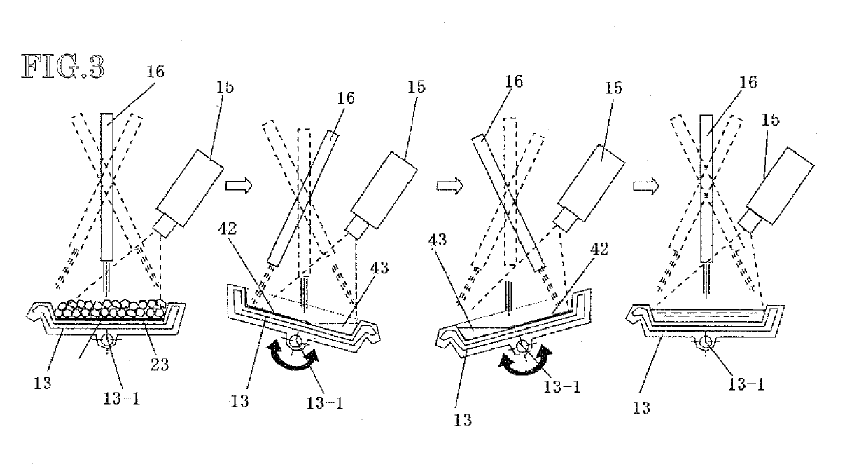

The impurity removal effect based on the relative movements between the molten silicon and the hearth wall inside the tilted rotary hearth 13 is of the same principle as in the case in which the hearth is driven to sees'w (two-way tilting hearth), so that we will explain this effect taking the two-way tilting hearth 13′ as the example, shown in FIGS. 3 (a) through (d), for the sake of convenience in explanation.

Water-vapor added plasma jet is irradiated from the plasma torch 15 to the raw silicon supplied into the two-way tilting hearth 13′, whereby the silicon is melt down, and the molten silicon collects as melt 43 in the bottom of the hearth 13′, and as the silicon solidifies on the inner wall of the water-cooling hearth (or graphite hearth) skull 42 is formed (chart a).

As the silicon in the hearth 13′ is further melted to start the refinery step of oxidization and evaporation of boron, the boron in the molten silicon is oxidized by means of the water-vapor added plasma jet and evaporates from the melt surface, which causes the boron concentration in the molten silicon to decrease; however the boron in the solidified skull stays coagulated and barely participate in this refinery phenomenon.

By virtue of this water-vapor added plasma jet, the boron inside the molten silicon is oxidized and is vaporized and removed in the form of oxides, typically B₂O₃, whose vapor pressures are relatively high. However, as disclosed and reported in IP Publication 2 and non-IP Publication 2, although boron's oxidation and evaporation phenomena are effected by means of the thermal plasma added with H₂O or CO₂ or the like, the melt surface is covered with silicon oxide (SiO₂) film and this suppresses boron's oxidation and evaporation rates so that the lengthy boron treatment time has been a problem. On the other hand, silicon itself is vaporized and lost in the form of SiO or the like, and as the treatment time increases so does the loss of silicon—hence another problem.

Also as is reported in non-IP Publication 2, boron is oxidized at a higher rate than silicon does at temperatures over about 1350 degrees centigrade, so that in this invention the treatment is conducted at relative high temperatures such as 1600-2300 degrees centigrade. By so doing, the evaporation of boron oxide is promoted and at the same time the silicon oxide (SiO₂) covering the molten silicon surface is vaporized in the form of SiO.

Now when the hearth 13′ is tilted in one direction about the tilting shaft 13-1, as shown by the arrow, the molten silicon 43 in the hearth 13′ moves toward that part of the wall of the hearth 13′ which has just tipped down (right-hand side in the figure), and on the other hand the skull 42 consisting of the coagulated layer sticking to that part of the wall which has tipped up (left-hand side in the figure) comes out of the melt and is exposed to the atmosphere of the water-vapor added plasma arc or of the low-pressure oxygen plasma arc (chart b).

The skull 42 which has directly received the irradiation of the water-vapor added plasma arc or the low-pressure oxygen plasma arc is melted and flows on the wall of the hearth 13′ and enters into the molten silicon 43 pooled in the opposite part. In this step, the surface of the skull 42 is melted by the heat from the irradiation of water-vapor added plasma jet so that the coagulated silicon surface is renewed and the boron therein is oxidized and evaporated. Furthermore, by repeating this step, a new melt face is always exposed and this too experiences the further melting and the oxidation and evaporation of boron so that boron is quickly removed by being evaporated from the surface.

This skull melting step is continued until the skull has melted away and the cooling from the hearth wall and the heating by the irradiation of the water-vapor added plasma arc or of the low-pressure oxygen plasma arc have been equilibrated. By this, the exposed surface of the skull where the melting by means of the irradiation of the water-vapor added plasma arc or of the low-pressure oxygen plasma arc proceeds simultaneously as the oxidized evaporation of boron becomes the most active and effective region for the boron removal operation.

After the completion of this born removal step which is effected by the melting of the skull on one side of the hearth 13′ and the boron's oxidized evaporation, as stated above, the hearth 13′ is then tilted on the other side around the tilting shaft 24, whereby the molten silicon 43 moves toward that part of the wall of the hearth 13′ which has now tipped down (left-hand side in the figure), and on the other hand the skull 42 consisting of newly formed coagulated layer sticking to that part of the wall which has tipped up (right-hand side in the figure) comes out of the melt and is exposed to the atmosphere of the water-vapor added plasma arc and, similarly as above, the skull 42 is melted and the boron's oxidized evaporation proceeds (chart c). By repeating the steps of chart b and chart c, the impurities created in the coagulated layer (skull) is continually removed and throughout this repetition the boron in the melt as a whole is effectively removed.

On the other hand, the melt pool in which the molten skull flows in experiences an overall agitation by the incoming flow of the molten silicon so that the boron in the melt pool is transported towards the melt surface together with molten silicon, and thus being exposed to the water-vapor added plasma jet, the born is oxidized and evaporated.

The tilted rotary hearth 13 shown in FIG. 2 and the two-way tilting hearth 13′ shown in FIG. 3 are both characterized in that the molten silicon is repeatedly moved relative the hearth wall as it is kept being melted by the irradiation of the water-vapor added plasma jet in a manner such that by rushing to the lower part of the wall it drenches the entire parts of the hearth wall one after another. By this contrivance, the impurity-containing coagulated layer (skull) which is sticking to the temporarily upper part of the wall is directly exposed to the water-vapor added plasma jet irradiation, whereby the skull sticking to the wall of the hearth 13, 13′ is melted, oxidized and evaporated to promote effective boron removal treatment. Therefore, the purification container used in the present invention can be the tilted rotary hearth 13 shown in FIG. 2 or the two-way tilting hearth 13′ shown in FIG. 3, or it can be one which is a hybrid of the FIG. 2 tilted rotary hearth 13 with the two-way tilting function of FIG. 3 hearth.

Now, turning back to FIG. 2, the plasma torch 15 is disposed to irradiate water-vapor added plasma jet to the silicon inside the tilted rotary hearth 13 to thereby melt the silicon, but it is also adapted to sweepingly cast the plasma arc irradiation so as to be able to irradiate at that part of the wall of the rotary tilted hearth 13 which is tipped up and exposes skull as well as that part of the wall which is tipped down to have collected the molten silicon. This sweeping of the plasma jet may be a kind wherein the plasma torch is mechanically driven or a kind wherein the plasma torch 15 itself is stationary but a magnetic coercing or the like is applied to the plasma arc irradiated from the torch so as to change the irradiation direction of the plasma arc.

In many conventional applications, argon is used as the inert gas for exciting the plasma torch 16 for boron removal.

As described above, by the use of the tilted rotary hearth 13 or the two-way tilting hearth 13′, the silicon is kept molten as it is irradiated with the water-vapor added plasma jet while it is transported relative to the hearth wall continuously toward the descending area of the hearth wall (container bottom face), and the coagulated layer (skull) containing impurities sticking to the ascending portion of the container wall is directly exposed to the water-vapor added plasma jet irradiation. As the result, the skull sticking to the inner wall of the hearth 13 or the hearth 13′ is melted, oxidized and evaporated and thereby an effective boron removal is promoted, but in this procedure, the fact is that not only the boron is effectively removed through oxidation but also much of the phosphorus, which is known difficult to remove from metallic silicon, can be removed with a result that the thermal burden born by the phosphorus removal step, herein-below described, is considerably reduced.

### <Phosphorus Removal Step>

In FIG. 1, the inside of the vacuum chamber 10 after the completion of the boron removal step is rapidly sucked by means of a combination of vacuum pumps P1, P2, constituted by mechanical booster pumps serially connected in duo tandem, and a vacuum pump P3, whereby, in the case of a chamber 10 roughly measuring 2.2 m in inner diameter by 2 m in inner height, the interior pressure changes from the state of 100-400 Torr to a high vacuum state of 10⁻² Torr or thinner (e.g. 10⁻³ Torr or so), which is suitable to water-vapor added plasma jet irradiation, within 30 seconds. In this manner, the vacuum chamber 10 is maintained to have a vacuum atmosphere of 10⁻² Torr or thinner (e.g. 10⁻³ Torr or so), and the phosphorus evaporating from the molten silicon is rapidly exhausted from the vacuum system.

Inside the vacuum chamber 10, the tilted rotary hearth 13 now contains the refined molten silicon form which boron has been evaporated by the water-vapor added plasma jet in the first step. This refined molten silicon is kept in its molten state throughout the switching period wherein the atmosphere in the vacuum chamber 10 is switched over by means of the booster vacuum pumps P1, P2, P3 connected in tandem within 30 seconds. This maintenance of the molten state is as the result of the heat insulation effect of the coagulated layer (skull) sticking to the wall of the hearth 13 as well as the vacuum insulation effect inside the vacuum chamber 10. Therefore, it is desirable that after the completion of the boron removal treatment the rotation of the tilted rotary heath 13 as well as the water-vapor added plasma jet irradiation is stopped and stayed temporarily in a state, for example as shown in FIG. 3 (d), and thereafter the rapid vacuum sucking from the vacuum chamber 12 is conducted with the vacuum pumps P1, P2.

When the suction of the vacuum chamber 10 is completed, the tilted rotary hearth 13 is driven, and at the same time the irradiation of the electron beam upon the refined molten silicon contained in the hearth by means of the electron beam irradiation apparatus 15 is started to thereby begin heating of the molten silicon.

During this step of heating the refined silicon melt, the molten silicon is exposed to the vacuum atmosphere, and as the result the phosphorus existing as an impurity starts evaporating. The reaction condition required at this step for the phosphorus removal to proceed at a high rate is to raise the temperature of the molten silicon to about 1600 degrees centigrade because the melting point of silicon is 1420 degrees centigrade and the evaporation temperature of phosphorus is 1300 degrees centigrade.

The molten silicon is heated in the tilted rotary hearth 13 by means of the electron beam from the electron beam irradiation apparatus 15. This electron beam irradiation apparatus 15 is adapted to irradiate the electron beam sweepingly throughout the whole of the molten silicon 43 and the skull 42 within the hearth 13, 13′. The movement of the tilted rotary hearth 13 or the two-way tilting hearth 13′, the relative movement between the wall of these hearths 13 and the molten silicon, the exposure of the skull on the uprising wall, the thermal melting of the skull and the agitation effect of the molten silicon 23, etc. during the phosphorus removal step by means of the electron beam irradiation are the same as those in the case of afore-described boron removal step.

Therefore, we refer the readers to the explanation already given in relation to the boron removal step as depicted in FIGS. 2 and 3, and omit the phosphorus removal version of the explanation Anyhow, in this phosphorus removal step, it is possible to remove effectively the phosphorus from the refined silicon melt contained in the hearth 13 by means of the heat of the electron beam irradiation from the electron beam irradiation apparatus 16.

Also, what with the fact that about 50% of phosphors contained in the raw silicon has been removed at the boron removal step, and also due to the fact that only object to be heated is silicon already in molten state in the hearth 13 so that the burden for the electron beam, irradiation apparatus required for phosphorus removal has been substantially reduced. For example, compared to a common phosphorus removal step wherein a 1200-KW strong electron gun is used at an output of about 900 KW, it is now possible to conduct the phosphorus removal treatment on the molten silicon in the tilted rotary hearth 13 using an electron gun of about one third of the output (about 250 KW-300 KW).

Also, in the above treatment step, if the vacuum level of the electron beam irradiation apparatus is raised and the electron beam irradiation is started before the vacuum level of the melting chamber reaches the level suitable for the boron removal treatment, it would be good in that during the transition to the phosphorus removal treatment the molten state of silicon is secured.

In the above steps of removing boron and phosphorus, the coagulated layer (skull) formed in the tilted rotary hearth containing molten silicon is directly exposed to the irradiation of water-vapor added plasma or electron beam so that it does not necessarily happen that the melt surface is excessively heated, and as the result the evaporation of silicon is suppressed and thus pollution and wear of the hearth are also suppressed.

After the steps of removing boron and phosphorus, the tilted rotary heart 13 is canted to pour the molten silicon into the melt holding container 20. This melt holding container 20 is heated by the heater 21 and thus the silicon held inside is securely maintained in its molten state with uniform temperature.

After repeating the supply of the raw silicon to the tilted rotary hearth 13, the boron removal step, the phosphorus removal step and the pouring of molten silicon into the melt holding container 20 a number of times, and when the holding container 20 is filled with the molten silicon, it is now possible to conduct the one-way coagulation, as described below.

In this scenario the molten silicon pooled in the melt holding container 20 is kept heated by the heater 21 and thus its molten state is preserved and when a predetermined amount is reached, the container is transported to one of the one-way coagulation chambers 17 and the one-way coagulation is conducted.

### (One-Way Coagulation Apparatus)

One-way coagulation chambers 17 (−1, 2) are adjacently connected via respective gate valves to the melting chamber, and as described above the molten silicon which has gone through the boron removal and the phosphorus removal steps in the melting chamber is pooled in the melt holding container, and then carried to the next one-way coagulation step.

The melt holding container is a graphite crucible lined with silica in an amount of 500 kg volume per batch, and is holding several batches each in an amount of 50 kg from the boron removal step and the phosphorus removal step, respectively, in it, and while keeping the molten state at a certain temperature not lower than about 1420 degrees centigrade by means of the heater 21, the container is lowered by the lifter 22 and is transported sideway on the platform 26 into one of the one-way coagulation apparatuses 17(−1, 2) by way of the respective gate valve.

The one-way coagulation chamber 17, which constitutes the one-way coagulation apparatus, has been drawn to a vacuum by means of a vacuum pump P1-2, and the melt holding container is lowered by the lifter 25 (−1, 2) at a predetermined velocity (e.g., 30 mm/minute) within the one-way coagulation chamber 17 to depart from the heating zone consisting of the side heater 23(−1, 2) and the top heater 24, with the melt surface continuously kept in the molten state by means of the heating zone, whereby coagulation starts from the bottom part and eventually the top part enriches in the impurities consisting of transition metals such as iron and aluminum thanks to the differences in the solid-liquid distribution coefficient, and these parts are cut off to provide a high-purity silicon.

It is estimable that the purities reported in the above-mentioned publications are achieved through these steps of the present invention, but in view of the nature of these steps, it is possible to refine the silicon to even higher purities. For example, it is possible to obtain satisfactory results in terms of the boron removal and the phosphorus removal by means of the present invention, but depending on the kind of raw silicon used, it may not be possible to remove other impurities sufficiently if the one-way coagulation is conducted only one time, and as a result it may be thinkable that the purity of 6 n-7N is not achieved. In such a case, it is desirable that the raw silicon is preliminarily subjected to an optional one-way coagulation treatment in the one-way coagulation apparatus, and is thereafter pulverized or otherwise prepared to make a preliminarily refined silicon raw material, which is then supplied to the vacuum screw feeder 14 as the starting silicon. In this way, in addition to the boron and phosphorus, the other impurities are also removed and it is possible more securely to obtain SOG silicon of 6N-7N purities.

Incidentally, in the present invention, we have taken as examples for the silicon purification container the tilted rotary water-cooling hearth and the two-way tilting water-cooling hearth, but, unlike the conventional hearth whose primary object is merely to provide a container to pool the molten silicon, the object for this hearth of the present invention is to repeatedly move the silicon relative to the hearth wall as it is kept molten by being irradiated with the water-vapor added plasma jet or the electron beam so that the molten silicon incessantly collects in the lowered part of the hearth wall (the bottom wall of the container), and that the coagulated layer (skull) sticking to the up-risen part of the hearth wall and containing impurities is directly exposed to the water-vapor added plasma jet or the electron beam so as to be melted, oxidized and evaporated to effectively release the boron and phosphorus, whereby the coagulated layer formed as skull on the hearth's inner wall is turned to be the area where these purification reactions occur most progressively and another object of the present heart is to impart an agitation effect so as to transfer the phosphorus and boron toward the melt surface where reactions take place, and therefore it suffices in short that the hearth of the present invention has the abilities of bringing the parts of the hearth's bottom wall and of the hearth's inner side wall stuck with coagulated layer out of the wash of the melt pool area, where molten silicon gathers, to thereby expose them to these atmospheres and at the same time the ability of moving the melt to effect agitation.

Furthermore, in these examples a water-cooling copper hearth is used as the container for melting silicon, but it can be made of graphite or other materials so long as the above-described steps of boron removal and phosphorus removal from the silicon can be executed, and also nor particular shape or construction are required of the container.

In the above examples, it has been described such that firstly the raw silicon held in the hearth installed in the chamber is subjected to the first melting treatment (heating with water-vapor added plasma arc or with low-pressure oxygen plasma arc) to thereby melt and maintain the silicon in a high temperature molten state so that boron is removed as it is oxidized and the oxide is evaporated, and then secondly in the same chamber the molten silicon held in the hearth and maintained in the molten state is subjected to the second melting treatment (heating with electron beam irradiation) to thereby render the silicon in a high temperature molten state so that phosphorus is removed as it is evaporated; however it is possible to reverse the sequence of the first and the second steps.

This reversed steps consist firstly of putting the raw silicon held in the hearth into a high temperature molten state by irradiating it with electron beam to thereby effect the removal of phosphorus by its evaporation, and secondly of subjecting the molten silicon held in the hearth in the same chamber to the second melting treatment (heating with water-vapor added plasma arc or with low-pressure oxygen plasma arc), while keeping the silicon in its molten state, to thereby put the silicon into a high temperature molten state so that boron is removed as it is oxidized and the oxide is evaporated. Furthermore, in this sequence, it is desirable that the irradiation of electron beam is repeated after the step of plasma irradiation to thereby render the silicon in a still better molten state to promote the evaporation of phosphorus. (If it seems necessary, after this step the plasma irradiation step and the electron beam irradiation step may be conducted.)

In these, before conducting the electron beam irradiation step, the vacuum pumps P2-P3, shown in FIG. 1, are first driven and thereafter the vacuum pump P9 is driven to render the inside of the chamber 1 in a high level vacuum of 10⁻² Torr or thinner (e.g., about 10⁻³ Torr), and then the raw silicon held in the hearth is irradiated with the electron beam from the electron beam irradiation apparatus 16 whereby phosphorus is removed as it evaporates. Also, prior to the plasma irradiation step, some inert gas is introduced into the chamber 10 until the inner pressure becomes 200-400 Torr or so, and then the heating with water-vapor added inert gas plasma arc or with low-pressure oxygen inert gas plasma arc is started to thereby let boron oxidize and evaporate for its removal.

As one of methods for forming a highly purified silicon ingot from the molten silicon after the completion of the boron and phosphorus removal treatments, we described the one-way coagulation purification procedure; however, it is possible to adopt some other method so long as it is capable of coagulating the silicon while availing the effect of the difference in the solid-liquid distribution coefficient and removing the impurity-rich part(s), and such alternative methods include publicly known ones such as refinery process zone melting method, and such alternative method can replace the one-way coagulation method or can be used as a part of a combination with some mandatory step.

After the completion of these steps of removing phosphorus and boron, the present invention prescribes a coagulation step such as one-way coagulation to thereby remove the impurities and further improve the purity.

This step is not only necessary for the purpose of removing the remnant impurities but also effective in suppressing the purity degradation caused by the pollution with the impurities which come to admix during the purification steps for the removal of phosphorus and boron.

Incidentally, as described above, although the purification process for the removal of the phosphorus and boron of the present invention not only brings about good productivity result but also achieves an extraordinarily high purity, these purification steps involve reactions which take place solely in the interface across the melt surface notwithstanding the agitation effect, so that the treatment amount per batch cannot but have a limited appropriate range.

Furthermore, the above-said purification process according to the present invention has an extraordinarily high purification rate as well as a high productivity, but if the refinery step of the one-way coagulation procedure is conducted continuously, since the one-way coagulation procedure involves gradual coagulation which is effected upwardly from below by slowly moving vertically the heating zone or the container while keeping uniform the temperature of the molten silicon in the container, the time required per batch is long. For this reason, in order to arrange the entire purification process of the present invention from the phosphorus and boron removal steps through the one-way coagulation step in a continuously sequenced manner, it is necessary to construct a structure wherein a plurality of one-way coagulation purification apparatus as many as the production rate requires are operated simultaneously as the melting and refining steps proceed.

Therefore, in the present invention, to attain a continuous and break-free operation, it would be necessary to adopt a purifying system wherein the molten silicon from the purification container after the removal of phosphorus and boron is temporarily retained in the melt holding container from which it is distributed to a plurality of one-way coagulation apparatus to thereby establish a balance among the production steps.

1. A method for purifying silicon comprising: a plasma irradiation step, in which boron contained in a molten metallic silicon is oxidized and removed by heating said molten metallic silicon with irradiation of a plasma gas consisting of an inert gas mixed with an oxygen-containing gas to the melt surface of said metallic silicon contained in a silicon melting container installed in a vacuum chamber in a plasma irradiation-suitable vacuum atmosphere having a relatively low degree of vacuum, and an electron beam irradiation step, in which phosphorus contained in said metallic silicon is removed by evaporation by heating said molten silicon with irradiation of electron beam in an electron beam-irradiation suitable vacuum atmosphere having a relatively high degree of vacuum; characterized in that,
after conducting either of said plasma irradiation step or said electron beam irradiation step,
within a pursuing time period in which the molten state of said molten silicon contained in said melting container is maintained, the atmosphere within said vacuum chamber is changed to either one of said electron beam-irradiation suitable vacuum atmosphere and said plasma irradiation-suitable vacuum atmosphere which is suitable to that step which has not yet been conducted; and then this not-yet-conducted step is conducted,
and thereby using the same chamber and the same melting container boron and phosphorus are removed from said metallic silicon.

2. A method for purifying silicon to obtain a purified unit amount of purified silicon comprising: a plasma irradiation step, in which boron contained in a molten metallic silicon is oxidized and removed by heating said molten metallic silicon with irradiation of a plasma gas consisting of an inert gas mixed with an oxygen-containing gas to the melt surface of said metallic silicon, which amounts to less than said purified unit amount, in a silicon melting container installed in a vacuum chamber in a plasma irradiation-suitable vacuum atmosphere having a relatively low degree of vacuum, and an electron beam irradiation step, in which phosphorus contained in said metallic silicon is removed by evaporation by heating said molten silicon with irradiation of electron beam in an electron beam-irradiation suitable vacuum atmosphere having a relatively high degree of vacuum; characterized in that,
after conducting either of said plasma irradiation step or said electron beam irradiation step,
within a pursuing time period in which the molten state of said molten silicon contained in said melting container is maintained, the atmosphere within said vacuum chamber is changed to either one of said electron beam-irradiation suitable vacuum atmosphere and said plasma irradiation-suitable vacuum atmosphere which is suitable to that step which has not yet been conducted; and then this not-yet-conducted step is conducted,
and thereby using the same chamber and the same melting container boron and phosphorus are removed from said metallic silicon, and the molten silicon contained in the melting container is transferred to a melt holding container wherein the molten silicon is kept molten,
then, these steps are repeated in said order until said purified unit amount of purified silicon is obtained.

3. A method for purifying silicon as claimed in claim 1, characterized in that, after conducting said plasma irradiation step in said vacuum atmosphere having the relatively low degree of vacuum, within said pursuing time period in which the molten state of said molten silicon contained in said melting container is maintained, said vacuum chamber is rapidly sucked and thereby changed to said electron beam-irradiation suitable vacuum atmosphere having said relatively high degree of vacuum; and then said electron beam irradiation step is conducted.

4. A method for purifying silicon as claimed in claim 3, characterized in that, prior to conducting said plasma irradiation step in said vacuum atmosphere having the relatively low degree of vacuum, electron beam is irradiated to unrefined raw silicon contained in said melting container to thereby rapidly melt said raw silicon while the vacuum chamber retains said relatively high level of vacuum.

5. A method for purifying silicon as claimed in claim 1, characterized in that said atmosphere having the relatively low degree of vacuum retained by said vacuum chamber for plasma irradiation step consists of an inert gas atmosphere of 100-40 Torr and the degree of vacuum for said electron beam irradiation step is thinner than 50×10⁻² Torr.

6. A method for purifying silicon as claimed in claim 3, characterized in that the step for sucking said vacuum chamber to a state of said electron beam-irradiation suitable vacuum atmosphere consists of a sub-step of recovering the inert gas filling said chamber by rapidly sucking with a tandem of booster pumps connected to the vacuum chamber during a beginning stage of said sucking step.

7. A method for purifying silicon as claimed in claim 1, characterized in
that said melting container is driven to undergo a movement in a manner such that a pool of the molten silicon in said melting container moves relative to the inner wall of the container to thereby expose all parts of a silicon coagulated layer formed on said inner wall one after another, and that in said plasma irradiation step the plasma consisting of the inert gas mixed with an oxygen-containing gas is irradiated to said silicon coagulated layer formed on said wall of the container in the vacuum atmosphere of the relatively low degree of vacuum to thereby melt this layer and oxidize the boron and dispel it from the molten silicon, and
that in said electron beam irradiation step the electron beam is irradiated to said silicon coagulated layer formed on the wall of the container in the vacuum atmosphere of the relatively high degree of vacuum to thereby melt said layer and remove boron from the molten silicon by evaporation.

8. A method for purifying silicon as claimed in claim 7, characterized in that said silicon melting container, which handles said silicon coagulated layer, consists of a rotary container with a tilted rotary shaft which renders the container to rotate not horizontally.

9. A method for purifying silicon as claimed in claim 7, characterized in that said silicon melting container, which handles said silicon coagulated layer, consists of a two-way tilting container which is adapted to tilt in opposite directions.

10. A method for purifying silicon as claimed in claim 7, characterized in that said silicon melting container, which handles said silicon coagulated layer, consists of a wobbleable container which is capable of rotating not horizontally and tilting in two opposite direction at the same time.

11. A method for purifying silicon as claimed in claim 1, characterized in that said oxygen-containing gas constituting said plasma gas is water vapor.

12. A method for purifying silicon as claimed in claim 1, characterized in that the molten silicon which went through the plasma irradiation step and the electron beam irradiation step is subjected to a coagulation step which makes use of difference in solid-liquid distribution coefficient, and thereafter that part of the coagulated silicon which is rich in impurities is cut off to obtain a highly purified silicon ingot.

13. A system for purifying silicon characterized by comprising:
a vacuum chamber adapted to change its inner atmosphere between a lower-degree vacuum atmosphere and a higher-degree vacuum atmosphere,
a melting container for containing molten silicon installed in said vacuum chamber,
a plasma irradiation apparatus for irradiating a plasma consisting of an inert gas mixed with an oxygen-containing gas to a melt surface of metallic silicon contained in said melting container to thereby heat the molten silicon and oxidize and remove boron contained in the metallic silicon,
an electron beam irradiation apparatus for irradiating electron beam to the melt surface of metallic silicon contained in said melting container to thereby heat the molten silicon and remove phosphorus contained in the metallic silicon by evaporation, and
an atmosphere changing means for changing from a vacuum atmosphere in said vacuum chamber in which boron or phosphorus has been removed from said metallic silicon by a heating operation upon the melt surface of said metallic silicon contained in the melting container by means of either said plasma irradiation apparatus or said electron beam irradiation apparatus to another vacuum atmosphere which is suitable to the heating operation by said plasma irradiation apparatus or said electron beam irradiation apparatus whichever is not operated in foregoing vacuum atmosphere, within a time period wherein said molten silicon contained in said melting container remains molten,
said system being further characterized in that:
said either one of plasma irradiation apparatus or electron beam irradiation apparatus which is operated later is operated to heat the metallic silicon to thereby remove either phosphorus or boron from the metallic silicon, and thus
both phosphorus and born are removed from the metallic silicon using only one chamber and only one melting container.

14. A system for purifying silicon to obtain a purified unit amount of purified silicon, characterized by comprising:
a vacuum chamber adapted to change its inner atmosphere between a lower-degree vacuum atmosphere and a higher-degree vacuum atmosphere,
a melting container for containing molten silicon in an amount less than said purified unit amount, installed in said vacuum chamber,
a plasma irradiation apparatus for irradiating a plasma consisting of an inert gas mixed with an oxygen-containing gas to a melt surface of metallic silicon contained in said melting container to thereby heat the molten silicon and oxidize and remove boron contained in the metallic silicon,
an electron beam irradiation apparatus for irradiating electron beam to the melt surface of metallic silicon contained in said melting container to thereby heat the molten silicon and remove phosphorus contained in the metallic silicon by evaporation,
an atmosphere changing means for changing from a vacuum atmosphere in said vacuum chamber in which boron or phosphorus has been removed from said metallic silicon by a heating operation upon the melt surface of said metallic silicon contained in the melting container by means of either said plasma irradiation apparatus or said electron beam irradiation apparatus to another vacuum atmosphere which is suitable to the heating operation by said plasma irradiation apparatus or said electron beam irradiation apparatus whichever is not operated in foregoing vacuum atmosphere, within a time period wherein said molten silicon contained in said melting container remains molten, and
a melt holding container for receiving and holding the molten silicon from said melting container wherein boron and silicon have been removed from the metallic silicon using only one chamber and only one melting container, and for maintaining the molten state of said metallic silicon,
said system being further characterized in that it is possible to repeat said receiving of the molten silicon from said melting container upon each completion of boron and phosphorus removal process until said purified unit amount of purified silicon is obtained.

15. A system for purifying silicon to obtain a purified unit amount of purified silicon characterized by comprising:
a vacuum chamber adapted to change its inner atmosphere between a lower-degree vacuum atmosphere and a higher-degree vacuum atmosphere,
a melting container for containing molten silicon in a melt unit amount, which is less than said purified unit amount, installed in said vacuum chamber,
a melting container for containing molten silicon installed in said vacuum chamber,
a plasma irradiation apparatus for irradiating a plasma consisting of an inert gas mixed with an oxygen-containing gas to a melt surface of metallic silicon contained in said melting container to thereby heat the molten silicon and oxidize and remove boron contained in the metallic silicon,
an electron beam irradiation apparatus for irradiating electron beam to the melt surface of metallic silicon contained in said melting container to thereby heat the molten silicon and remove phosphorus contained in the metallic silicon by evaporation,
an atmosphere changing means for changing from a vacuum atmosphere in said vacuum chamber in which boron or phosphorus has been removed from said metallic silicon by a heating operation upon the melt surface of said metallic silicon contained in the melting container by means of either said plasma irradiation apparatus or said electron beam irradiation apparatus to another vacuum atmosphere which is suitable to the heating operation by said plasma irradiation apparatus or said electron beam irradiation apparatus whichever is not operated in foregoing vacuum atmosphere, within a time period wherein said molten silicon contained in said melting container remains molten, and
a melt holding container for receiving and holding the molten silicon from said melting container wherein boron and silicon have been removed from the metallic silicon using only one chamber and only one melting container, and for maintaining the molten state of said metallic silicon, said melt holding container being adapted to receive the molten silicon by said melt unit amount repeatedly,
said system being further characterized in that it is possible to repeat said receiving of the molten silicon from said melting container until said purified unit amount of purified silicon has been produced in said melting container and received by said melt holding container to thereby obtain said purified unit amount of purified silicon.

16. A system for purifying silicon to obtain a purified unit amount of purified silicon characterized by comprising:
a vacuum chamber adapted to change its inner atmosphere between a lower-degree vacuum atmosphere and a higher-degree vacuum atmosphere,
a melting container for containing molten silicon in a melt unit amount, which is less than said purified unit amount, installed in said vacuum chamber,
a plasma irradiation apparatus for irradiating a plasma consisting of an inert gas mixed an oxygen-containing gas to a melt surface of metallic silicon contained in said melting container to thereby heat the molten silicon and oxidize and remove boron contained in the metallic silicon,
an electron beam irradiation apparatus for irradiating electron beam to the melt surface of metallic silicon contained in said melting container to thereby heat the molten silicon and remove phosphorus contained in the metallic silicon by evaporation,
an atmosphere changing means for changing from a vacuum atmosphere in said vacuum chamber in which boron or phosphorus has been removed from said metallic silicon by a heating operation upon the melt surface of said metallic silicon contained in the melting container by means of either said plasma irradiation apparatus or said electron beam irradiation apparatus to another vacuum atmosphere which is suitable to the heating operation by said plasma irradiation apparatus or said electron beam irradiation apparatus whichever is not operated in foregoing vacuum atmosphere, within a time period wherein said molten silicon contained in said melting container remains molten,
a melt holding container for receiving and holding the molten silicon from said melting container wherein boron and silicon have been removed from the metallic silicon using only one chamber and only one melting container, and for maintaining the molten state of said metallic silicon, said melt holding container being adapted to receive the molten silicon by said melt unit amount repeatedly, and
a plurality of one-way coagulation apparatus for receiving said melt holding container and conducting one-way coagulation upon the molten silicon in said melt holding container making use of difference in solid-liquid distribution coefficient, said molten silicon being in an amount equivalent to said purified unit amount which is the sum of melt unit amounts of the molten silicon obtained by repeating the upstream purification process each producing one melt unit amount of silicon at a time, and said one-way coagulation including a step of removing at least a part enriched in purities,
said system being further characterized in that an overall purification process including the boron removal and phosphorus removal steps and the one-way coagulation is carried out without a break.

17. A system for purifying silicon as claimed in claim 13, characterized by comprising an inert gas supplying apparatus for supplying a gas consisting of an inert gas mixed with an oxygen-containing gas to thereby create said lower-degree vacuum atmosphere in said vacuum chamber adapted to change its inner atmosphere between said lower-degree vacuum atmosphere and said higher-degree vacuum atmosphere, and
a pump assembly consisting in series of a plurality of booster pumps connected in tandem and a vacuum suction pump, said pump assembly being connected to said vacuum chamber to rapidly evacuate it to create said higher-degree vacuum atmosphere within a time period wherein said molten silicon contained in said melting container remains molten.

18. A system for purifying silicon as claimed in claim 13, characterized in that said melting container is adapted to be driven to undergo a movement in a manner such that said molten silicon contained in it moves relative to the inner wall of said melting container to thereby expose all parts of a silicon coagulated layer formed on said inner wall one after another, and
that said plasma irradiation step is adapted to irradiate, in said lower-degree vacuum atmosphere, said plasma consisting of an inert gas mixed with oxygen to a silicon coagulation layer formed on the inner wall of said melting container to thereby melt it and remove boron by oxidizing the same, and
that said electron beam irradiation step is adapted to irradiate, in said higher-degree vacuum atmosphere, said electron beam to a silicon coagulation layer formed on the inner wall of said melting container to thereby melt it and remove phosphorus by evaporating the same.

19. A system for purifying silicon as claimed in claim 17, characterized by comprising a recovery apparatus for recovering the inert gas with which said vacuum chamber is filled by rapidly sucking with said pump assembly comprising said tandem-connected booster pumps connected to the vacuum chamber whereby the atmosphere of the vacuum chamber is changed to an electron beam-irradiation suitable vacuum atmosphere, said recovery apparatus being also for circulating said recovered inert gas to said inert gas supplying apparatus.
